(19) United States
(12) Patent Application Publication
(10) Pub. No.: US 2008/0302300 A1
(43) Pub. Date: Dec. 11, 2008

(54) JIG FOR SURFACE-TREATMENT OF THREAD PORTION OF NUT

(76) Inventor: Jung Gul LEE, Busan (KR)

Correspondence Address: LADAS & PARRY LLP, 224 SOUTH MICHIGAN AVENUE, SUITE 1600, CHICAGO, IL, 60604, US

(21) Appl. No.: 12/132,704

(22) Filed: Jun. 4, 2008

(30) Foreign Application Priority Data
Jun. 5, 2007 (KR) 10-2007-0054991

(51) Int. Cl. B05C 13/02

(52) U.S. Cl. 118/500

(57) ABSTRACT

Provided is a jig which is used! to perform surface-treatment, for example, such as plating or coating of only a thread portion formed in the inside of at least one nut. The jig includes: two multi-hole plates having one or more nut insertion holes which are penetratively formed therein, wherein a stepped portion is formed at the end of one side of each nut insertion hole, and wherein the two multi-hole plates symmetrically contact each other so that the respective stepped portions of the nut insertion holes are outwardly positioned in the nut insertion holes; an O-ring which is! inserted into each nut insertion hole so as to be stopped by the stepped portion; and coupling units which make the two multi-hole plates contact and fixed to each other.

### CROSS-REFERENCE TO RELATED APPLICATION

This application claims the benefit of Korean Patent Application No. 10-2007-0054991, filed on Jun. 5, 2007, and then registered as Korean Patent Registration No. 10-0770667 on Oct. 22, 2007, in the Korean Intellectual Property Office, the disclosure of which is incorporated herein by reference.

### BACKGROUND OF THE INVENTION

1. Field of the Invention

The present invention relates to a jig which is used to perform surface-treatment, for example, such as plating or coating of only a thread portion formed in the inside of at least one nut, and more particularly, to a jig for surface-treatment of only a thread portion formed in the inside of at least one nut, in which the jig includes a pair of upper and lower multi-hole plates which are coupled with each other by coupling units in which one or more nut insertion holes are penetratively formed so that the at least one nut can be simultaneously fixed and only the thread portion of the nut is surface-treated, for the purpose of preventing a burning and sticking phenomenon, enhancing air-tightness of gas such as helium, and improving torque, by plating only the thread portion of the nut or coating paint, lubricant oil, or resin on only the thread portion of the nut,

2. Description of the Related Art

Nuts are essential coupling units that are employed in all mechanical equipment. There are lock nuts, nuts for vehicle components, nuts for semiconductor equipment, nuts for aircraft, nuts for hydraulic pressure equipment, nuts for connecting pipes which convey fluid such as gas.

These nuts are surface-treated by plating or coating according to components used or under the respective environments of the places where the nuts are used, thereby preventing a burning and sticking phenomenon, improving a coupling torque, and enhancing air-tightness so that fluid such as gas is not leaked.

Surface-treatment of only a thread portion of a nut differs from surface-treatment of all sides of the whole nut. That is, surface-treatment of only a thread portion of a nut need not surface-treat all sides of the whole nut. Therefore, a jig for performing surface-treatment of only thread portions of the inside of the respective nuts, is needed.

In the case of the conventional art of plating only thread portions of the inside of respective nuts, paint or vinyl resin is coated on the outer surfaces of respective nuts so that the outer surfaces of respective nuts is not plated, and then the nuts whose outer surfaces are paint or vinyl resin coated are dipped into a plating solution so that the thread portions formed on the inner surfaces of the nuts are plated to perform surface-treatment of the nuts. Accordingly, a process of removing paint or vinyl resin coated on the outer surfaces of the nuts is essential.

Alternatively, in the case of the conventional art of plating only thread portions of the inside of respective nuts, the whole nuts are dipped into a vinyl resin solution, and then the vinyl resin is removed from the thread portions of the inside of the respective nuts. Then, the nuts whose outer surfaces have been paint or vinyl resin coated and from the inner surfaces of which the paint or vinyl resin has been removed are dipped into a plating solution so that the inner surfaces of the nuts are plated to perform surface-treatment of the nuts. In this case, since the removal work of the vinyl resin coated on the inner surfaces of the nuts dipped into the vinyl resin solution should be manually performed, accuracy and workability drop remarkably to accordingly cause a factor of increasing a manufacture unit cost.

Still alternatively, productivity is very low because it is to perform a manual processing of painting with a brush, in order to coat lubricant or resin on only thread portions of the inside of the respective nuts. As a result, quality is also lowered.

Therefore, it is very troublesome to perform surface-treatment of rust preventing or plating nuts so as to be suitable for components used or under the environment of the place where the nuts are used, in the case of the conventional art. Accordingly, the conventional art has a problem that productivity and workability are not good.

### SUMMARY OF THE INVENTION

To overcome defectives of the conventional art, it is an object of the present invention to provide a jig which is used to perform surface-treatment, for example, such as plating or coating of only a thread portion formed in the inside of at least one nut.

It is another object of the present invention to provide a jig which is used to perform surface-treatment, for example, such as plating or coating of only a thread portion formed in the inside of at least one nut, in which the at least one nut is simultaneously fixed to the jig and a plating solution or coating solution does not contact the outer surface of the at least one nut but contact only the thread portion of the inside of the at least one nut.

To accomplish the above object of the present invention, there is provided a jig which is used to perform surface-treatment, for example, such as plating or coating of only a thread portion formed in the inside of at least one nut, the jig comprising: two multi-hole plates having one or more nut insertion holes which are penetratively formed therein, wherein a stepped portion is formed at the end of one side of each nut insertion hole, and wherein the two multi-hole plates symmetrically contact each other so that the respective stepped portions of the nut insertion holes are outwardly positioned in the nut insertion holes; an O-ring which is inserted into each the nut insertion hole so as to be stopped by the stepped portion; and coupling units which make the two multi-hole plates contact and fixed to each other.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a perspective view showing the whole configuration of a jig which is used to perform surface-treatment, for example, such as plating or coating of only thread portions formed in the inside of respective nuts, according to the present invention;

FIG. 2 is a cross-sectional view showing a state where nuts are inserted into nut insertion holes formed on a jig according to the present invention; and

FIG. 3 is a perspective view showing a state where the thread portion formed in the inside of a nut has been plated.

### DETAILED DESCRIPTION OF THE INVENTION

Hereinbelow, a jig which is used to perform surface-treatment, for example, such as plating or coating of only a thread portion formed in the inside of at least one nut according to the present invention will be described with reference to the accompanying drawings. Like reference numerals are assigned for like elements in the drawings.

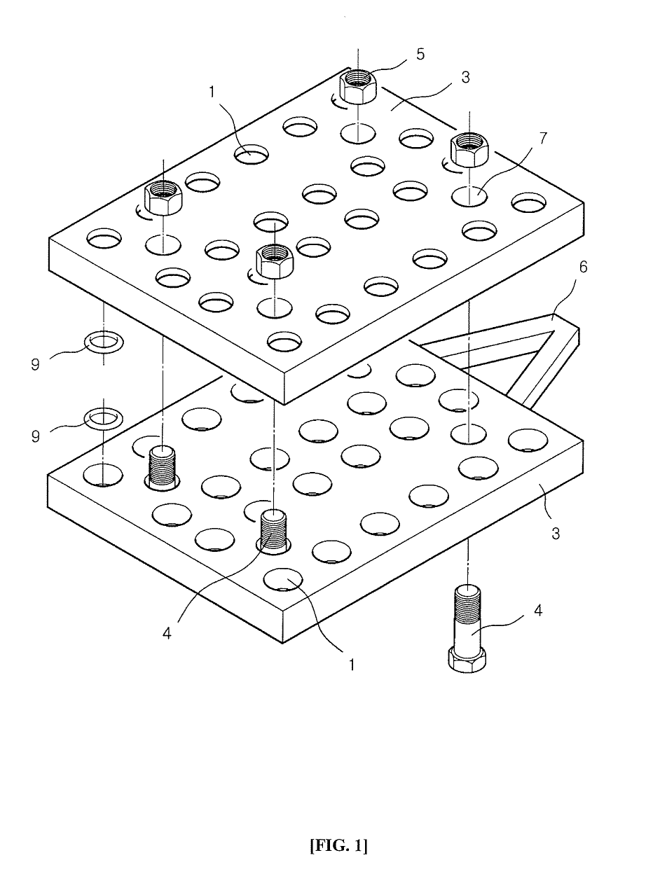

Referring to FIGS. 1 to 3, a jig which is used to perform surface-treatment, for example, such as plating or coating of only a thread portion formed in the inside of at least one nut will be described below. The jig includes two multi-hole plates 3 having one or more nut insertion holes 1 which are penetratively formed therein. A stepped portion 2 is formed at the end of one side of each nut insertion hole 1. The two multi-hole plates 3 symmetrically contact each other so that the respective stepped portions 2 of the nut insertion holes 1 are outwardly positioned in the nut insertion holes 1. An O-ring 9 is inserted into each nut insertion hole 1 so as to be stopped by the stepped portion 2. Coupling units which make the two multi-hole plates 3 contact and fixed to each other.

Each coupling unit which makes the two multi-hole plates 3 symmetrically contact and fixed to each other includes a jig coupling bolt 4 and a jig coupling nut 5, or may be implemented in various forms such as clips and tongs. In addition, a hook or ring 6 is formed in at least one of the multi-hole plates 3, so as to be used when the multi-hole plates 3 are dipped into a plating solution or coating solution (hereinafter, referred to as a surface-treatment solution).

Of course, as bolts and nuts are used as coupling units, bolt holes 7 for coupling the multi-hole plates 3 should be formed in the multi-hole plates 3.

The multi-hole plates 3 may be implemented using various kinds of materials such as polyvinyl chloride (PVC), urethane, metal, and rubber which do not melt in the surface-treatment solution.

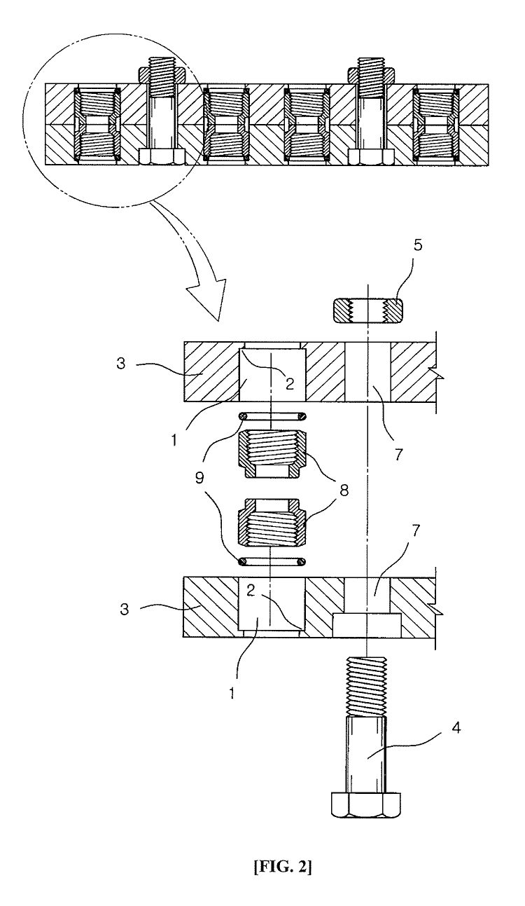

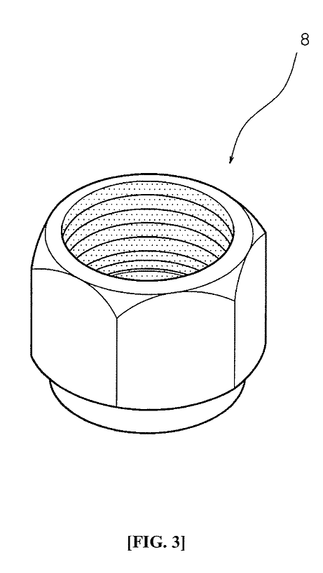

The whole configuration of a jig which is used to perform surface-treatment, for example, such as plating or coating of only thread portions formed in the inside of respective nuts, according to the present invention is illustrated in FIG. 1. A state where nuts 8 are inserted into nut insertion holes 1 formed on two multi-hole plates 3 of a jig for surface-treatment according to the present invention is shown in FIG. 2. A state where the thread portion formed in the inside of a nut 8 has been plated is shown in FIG. 3. O-rings 9 are inserted into the respective nut insertion holes 1 that are formed in the respective multi-hole plates 3 to perform surface-treatment. Then, nuts 8 to be surface-treated are inserted into the respective nut insertion holes 1. If the multi-hole plates 3 are thick, that is, if the respective nut insertion holes 1 are long, a number of nuts 8 can be inserted into a single nut insertion hole 1. In this case, an O-ring 9 may be inserted between a nut 8 and another.

As described above, if O-rings 9 and nuts 8 are inserted into all the nut insertion holes 1, the two multi-hole plates 3 are made to contact each other so that the respective stepped portions 2 of the nut insertion holes 1 are outwardly positioned in the nut insertion holes 1, as shown in FIG. 2. Then, as shown in FIG. 2, jig coupling bolts 4 are fitted into bolt holes 7 formed on the multi-hole plates 3 to then be tightly firmly coupled with jig coupling nuts 5.

If nuts 8 for surface-treatment are inserted into the nut insertion holes 1 formed on the jig as described above, nuts 8 are completely mounted in and fixed to the jig.

In addition, if the jig according to the embodiment of this invention is dipped into the surface-treatment solution using a hook or ring 6 formed on at least one of the multi-hole plates 3, only thread portions formed in the inside of the respective nuts are surface-treated.

That is, the surface-treatment solution flows into the thread portions of the respective nuts 8 through the spaces of the stepped portions 2 respectively formed in nut insertion holes 1, so that surface-treatment the thread portions of the respective nuts 8 is performed. However, the surface-treatment solution does not flow to the outer surfaces of the respective nuts 8 by the O-rings 9, but flows into only the inner portions of the respective nuts 8. As a result, the thread portions of the respective nuts are excellently surface-treated.

In the case that washing is needed in process, jig coupling bolts 4 and jig coupling nuts 5 are unlocked and released from the bolt holes 7. The multi-hole plates 3 are washed and then are made to contact each other. Then, the jig coupling bolts 4 and jig coupling nuts 5 are fitted into the bolt holes 7 and then tightened and locked. In addition, in the case that the surface-treatment solution is leaked toward the nut insertion holes 1 since the O-rings 9 are damaged, the surface-treatment solution is removed using a rotating or vibrating barrel.

After surface-treatment has been completed, the jig coupling bolts 4 and the jig coupling nuts 5 are unlocked and released to separate the two multi-hole plates 3. Accordingly, the plated nuts are taken out.

In addition, when washing is needed, the coupling units such as the jig coupling bolts 4 and the jig coupling nuts 5 are unlocked and released so that the multi-hole plates 3 of the jig are washed and re-used for the next process.

As described above, if the two multi-hole plates 3 in which one or more nut insertion holes 1 have been formed are made to overlap and contact each other to then perform surface-treatment, only the thread portions of a number of nuts 8 are surface-treated, to thereby enhance productivity as well as workability.

In addition, only the thread portions of the nuts are plated, coated, lubricated, or painted, in part, according to the kind of a surface-treatment solution. That is, only respectively different surface-treatment solution may be conveniently used according to components used or under the respective environments of the places where the nuts 8 are used.

Therefore, nuts for coupling pipe connectors which connect gas pipes which convey gas which may be easily leaked are surface-treated using a jig according to the present invention, to thereby prevent gas leakage effectively. Further, the jig according to the present invention may be generally applied to surface-treat a combination of a bolt and a nut for coupling various kinds of components and ornaments in various forms.

Thus, a number of nuts 8 are simultaneously surface-treated using the jig according to the present invention. As a result, the jig according to the present invention enhances productivity in view of surface-treatment of nuts to accordingly provide an effect of cost reduction. Further, the jig according to the present invention is excellent in precision to thereby mass-produce a good quality of products.

The present invention is not limited to the above-described embodiments. It is apparent to one who has an ordinary skill in the art that there may be many modifications and variations within the same technical spirit of the invention.

What is claimed is:

1. A jig which is used to perform surface-treatment, for example, such as plating or coating of only a thread portion formed in the inside of at least one nut, the jig comprising:
two multi-hole plates having one or more nut insertion holes which are penetratively formed therein, wherein a stepped portion is formed at the end of one side of each nut insertion hole, and wherein the two multi-hole plates symmetrically contact each other so that the respective stepped portions of the nut insertion holes are outwardly positioned in the nut insertion holes;
an O-ring which is inserted into each nut insertion hole so as to be stopped by the stepped portion; and
coupling units which make the two multi-hole plates contact and fixed to each other.
